(19) United States
(12) Patent Application Publication
(10) Pub. No.: US 2006/0097035 A1
(43) Pub. Date: May 11, 2006

(54) Size effective keypad switching and backlighting scheme

(75) Inventors: Julio C. Castaneda, Coral Springs, FL (US); Donald W. Burnette, Sunrise, FL (US); Francis M. Staszesky, Fort Lauderdale, FL (US); William J. Wingfield, Plantation, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: Motorola, Inc.

(21) Appl. No.: 10/984,046

(22) Filed: Nov. 9, 2004

(51) Int. Cl. G06C 7/02

(52) U.S. Cl. 235/145 R

(57) ABSTRACT

A mobile electronic device comprising a plurality of switches mounted on a printed circuit; a housing coupled to the printed circuit; a plurality of molded plungers for contacting the plurality of switches mounted on the printed circuit; and a keypad film coupled to the housing, wherein the keypad film has a convex shape around at least one of the molded plungers. A keypad for an electronic device comprising a plurality of molded plungers for contacting a plurality of switches mounted on a printed circuit; and a keypad film coupled to a housing of the electronic device, wherein the keypad film has a convex shape around at least one of the molded plungers keeping the at least one of the molded plungers in place.

### FIELD OF THE INVENTION

The present invention relates generally to electronic devices. Even more specifically, the present invention relates to keypads for electronic devices.

### BACKGROUND

Keypads are widely used throughout the telecommunications industry and other consumer product industries. One common application includes internal rubber or plastic keypads of which only the actual key protrudes through holes in the device housing.

One problem with this common design is that the front side of the Printed Circuit Board (PCB) or Flexible Printed Circuit (herein also referred to as Flex) can only be populated by LED's and/or perhaps a few components because Mylar popple switches which are used for the keypad take up the majority of the real estate on the PCB or the Flex. As referred to herein, the PCB, the Flex and any other type of circuit board are a printed circuit.

Additionally, because the film layer on the Mylar popple switches take up such a large amount of space, traditionally electronic devices, e.g., a cellular telephone, have had more than one PC board. A first PC board is used for the Mylar popple switches and a second PC board is used for the operational electronic components of the electronic device. For example, the processor and the memory of the electronic device are electrical components that can be located on the second PC board.

### BRIEF DESCRIPTION OF THE DRAWINGS

The features and advantages of the present invention will be apparent from the following description thereof, presented in conjunction with the following drawings wherein:

FIG. 1 is an isometric diagram illustrating two printed circuit boards for an electronic device using Mylar switches;

FIGS. 2 and 3 are exploded isometric diagrams illustrating an electronic device housing and a printed circuit board in accordance with one embodiment;

FIG. 4 is an isometric diagram illustrating the printed circuit board shown in FIG. 3;

FIG. 5 is a side cross sectional view illustrating a keypad and a printed circuit board in accordance with an embodiment;

FIG. 6 is a detailed side cross sectional view illustrating part of the keypad and the printed circuit board shown in FIG. 5;

FIG. 7 is a side cross sectional view illustrating an electronic device housing and keypad in accordance with another embodiment;

FIG. 8 is a detailed side cross sectional view illustrating part of the electronic device housing and the keypad of FIG. 7;

FIG. 9 is a flow diagram illustrating a method in accordance with one embodiment;

FIG. 10 is an isometric diagram illustrating an electronic device housing and a printed circuit board in accordance with an alternative embodiment;

FIG. 11 is a top cross sectional view illustrating an electronic device housing and printed circuit board in accordance with another embodiment;

FIG. 12 is an isometric diagram illustrating a printed circuit board for an electronic device in accordance with an embodiment;

FIG. 13 is an isometric diagram illustrating shielding on a printed circuit board for an electronic device in accordance with an alternative embodiment; and

FIG. 14 is a flow diagram illustrating a method in accordance with an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

The following description is not to be taken in a limiting sense, but is made merely for the purpose of describing the general principles of the invention. The scope of the invention should be determined with reference to the claims.

One embodiment can be characterized as a mobile electronic device comprising a plurality of switches mounted on a printed circuit; a housing coupled to the printed circuit; a plurality of molded plungers for contacting the plurality of switches mounted on the printed circuit; and a keypad film coupled to the housing, wherein the keypad film has a convex shape around at least one of the molded plungers.

Another embodiment provides a keypad for an electronic device comprising a plurality of molded plungers for contacting a plurality of switches mounted on a printed circuit; and a keypad film coupled to a housing of the electronic device, wherein the keypad film has a convex shape around at least one of the molded plungers keeping the at least one of the molded plungers in place.

A further embodiment may be characterized as a method for assembling an electronic device comprising providing a printed circuit having a plurality of switches mounted on a front side of the printed circuit; securing a housing to the printed circuit, the housing having a plurality of holes lined up with the plurality of switches mounted on the front side of the printed circuit; aligning a plurality of molded plungers with the plurality of switches mounted on the front side of the printed circuit; and coupling a keypad film to the housing, wherein the keypad film has a convex shape around the plurality of molded plungers.

An alternative embodiment may be characterized as a method for providing a keypad for an electronic device comprising the steps of forming a housing with a plurality of holes in a front of the housing coupling a printed circuit to the housing such that a plurality of switches on the printed circuit line up with the plurality of holes in the front of the housing; placing a plurality of plungers in the plurality of holes in the front of the housing; and coupling a keypad film to the housing such that the plurality of plungers are held in alignment with the plurality of switches.

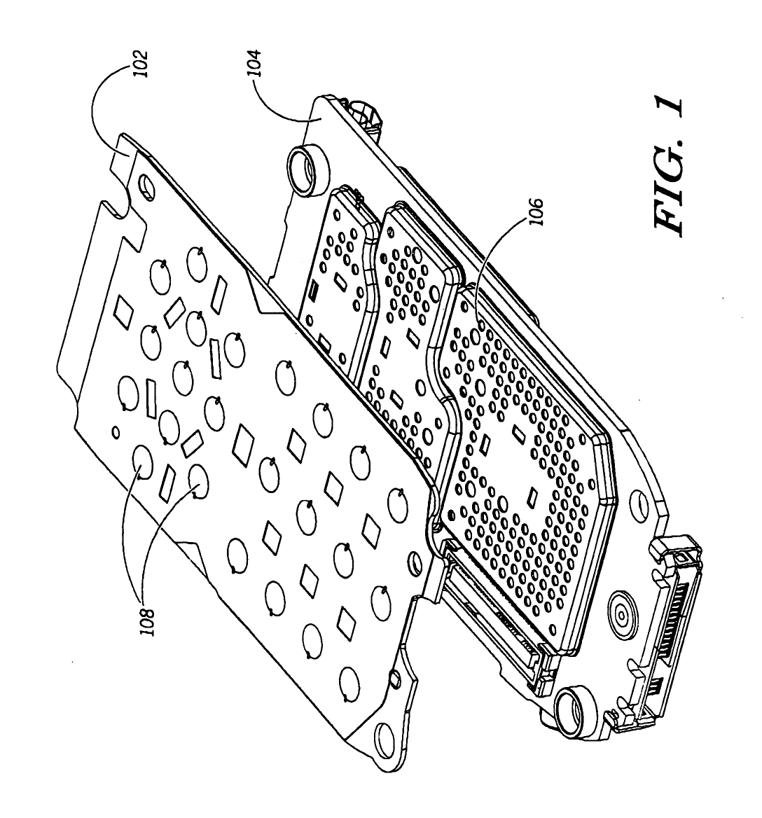

Referring to FIG. 1, an isometric diagram is shown illustrating two printed circuit boards for an electronic device. Shown is a first printed circuit board 102, a second printed circuit board 104, shielding 106, and a plurality of Mylar popple switches 108.

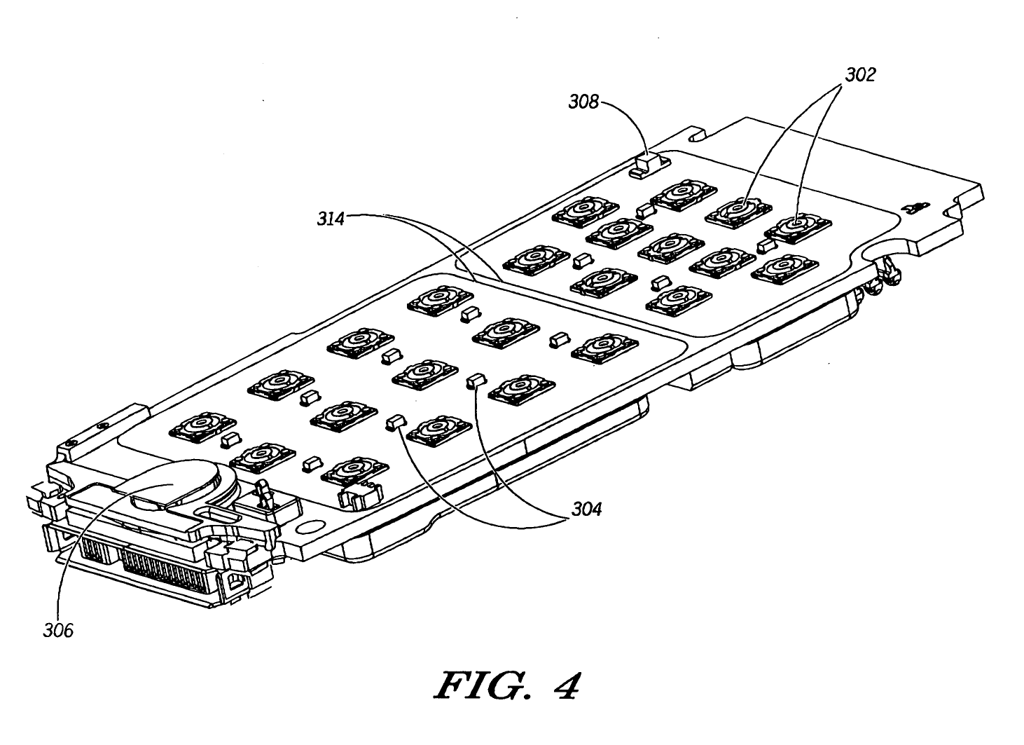

The second printed circuit 104 board includes most of the circuitry for the electronic device, e.g., memory, processor, clock, converters, and local oscillators. The first printed circuit board 102 contains primarily the Mylar popple switches 108. The Mylar popple switches 108 allow for a user of the electronic device to interact with the electronic device (i.e., enter inputs into the electronic device). For example, with a cellular telephone the user may enter in a phone number on a keypad in order to initiate a call. In operation, the user pushes a button on the cellular telephone that in turn presses down on the Mylar popple switches associated with the button. One problem with this design is the Mylar popple switches 108 take up a large amount of the space on the front of the first printed circuit board 102. Mylar popple switches are relatively large in comparison to discrete switches (shown herein for example in FIG. 4) and also require a large amount of space for adhesive that is used to hold the Mylar popple switches onto the first printed circuit board 102. This prevents other electronic circuitry, such as described above, from occupying much of the space on the first printed circuit board 102 because it is occupied by the Mylar popple switches 108.

In many electronic devices, such as cellular telephones, there are two printed circuit boards required in order to have a sufficient area for all of the electronic components. This can be undesirable, as many people prefer having small electronic devices such that they are easily transportable.

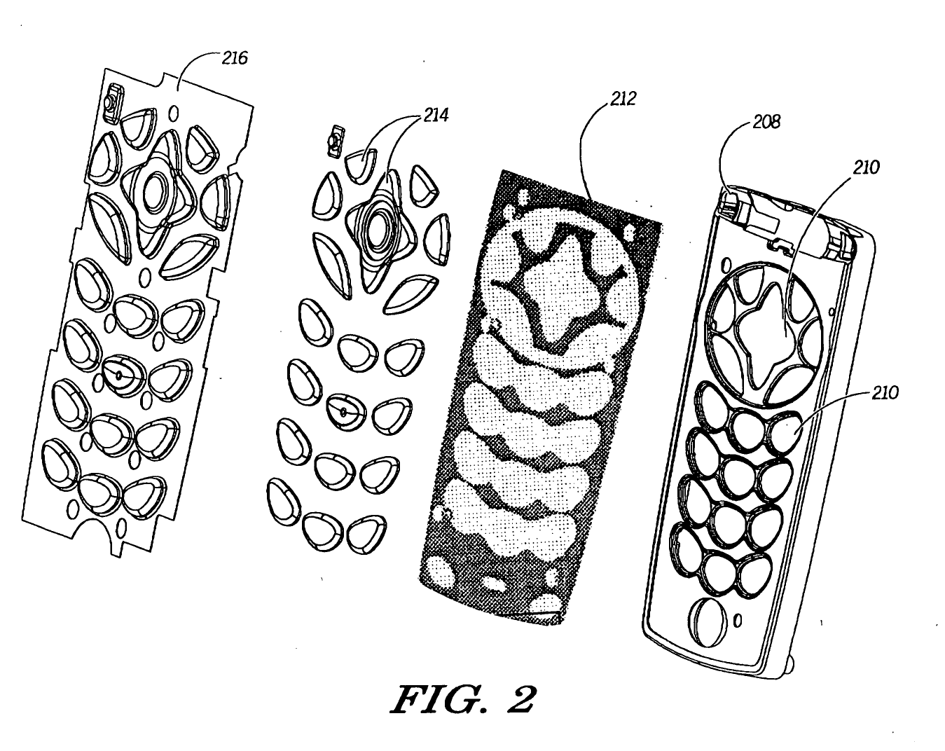

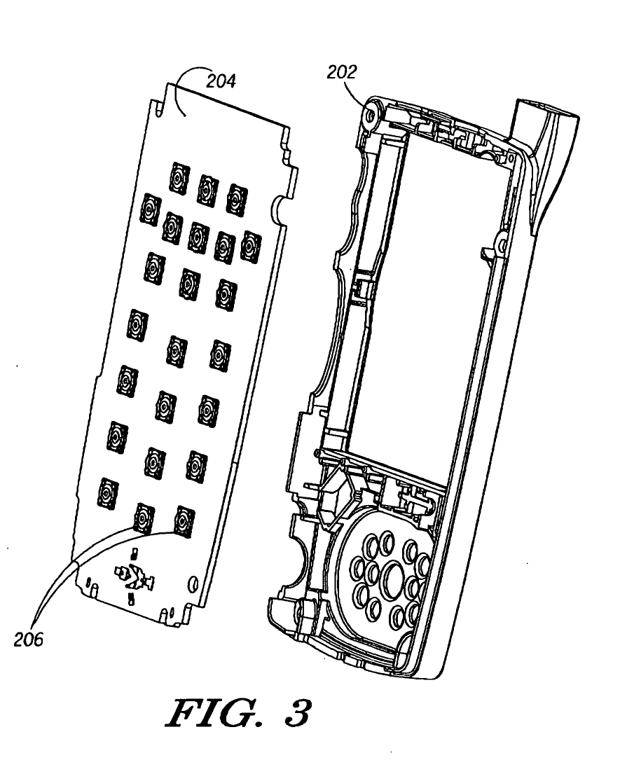

Referring to FIGS. 2 and 3, exploded isometric diagrams are shown illustrating an exploded view of a multi-layered electronic device housing and PC board in accordance with one embodiment. Shown is a back housing 202, a PC board 204, a plurality of switches 206, a front housing 208, a plurality of keypad holes 210, a keypad adhesive 212, a plurality of plungers 214, and a keypad film 216.

The electronic device can be any electronic device that requires a user interface. For example, the electronic device can be a cellular telephone, a pager, a two way pager, an organizer, and a combined cellular telephone and organizer. In accordance with a preferred embodiment, the electronic device is a cellular telephone.

When assembled, the back housing 202 is coupled to the PC board 204. The front housing 208 is also coupled to the back housing 202 such that the PC board 204 is held within the back housing 202 and the front housing 208. The front housing 208 includes the plurality of keypad holes 210. The keypad adhesive 212 is coupled to the front housing 208. In one embodiment, the keypad adhesive 212 can be pre-formed such that it does not cover the plurality of keypad holes 210 in the front housing 208. Alternatively, the keypad adhesive 212 can be attached to the front housing 208 and then have the portions of the keypad adhesive 212 that are covering the keypad holes 210 removed. The plungers 214 are placed in the keypad holes 210 such that the plungers 214 can contact the switches 206 on the PC board 204. The keypad film 216 is coupled to the front housing 208 by the adhesive 212 and such that the plungers 214 are held within the keypad holes 210. The keypad film 216 can be a vacuum formed film or a typical elastomeric keypad.

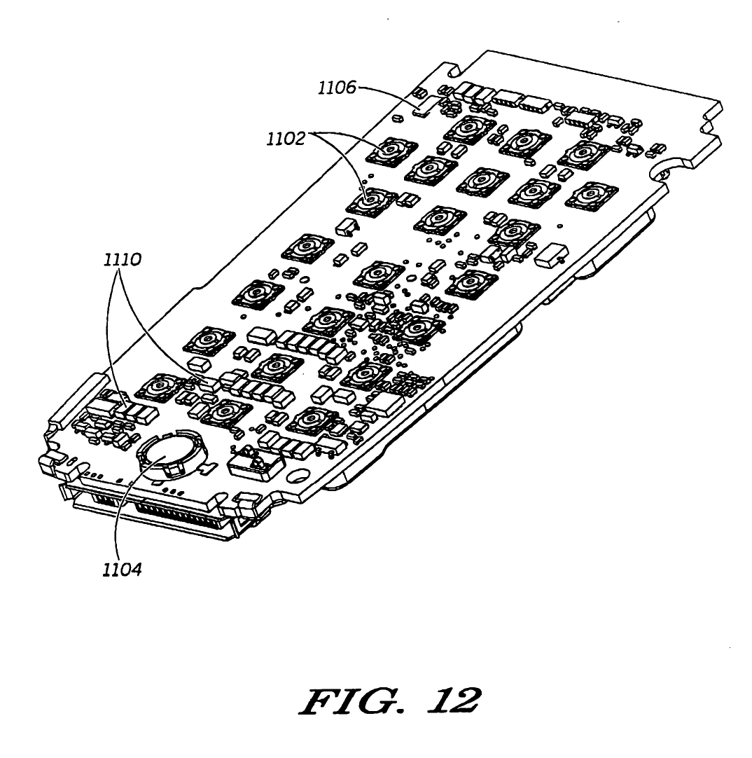

The plurality of switches 206 on the PC board 204 can be discrete switches that occupy less space on the PC board 204 as compared to Mylar popple switches. In one example, the switches are re-flow mounted tactile switches. Additionally, any type of method for mounting the switches can be used in accordance with the embodiments described herein. Fore example the switches can be machine placed or re-flow type switches. Alternatively, for example, the switches can also be hand placed and soldered or wave soldered. The space on the PC board 204 that was occupied by the Mylar popple switches can now be populated with electronic components. Electronic components can be place on both sides of the PC board 204 including the side that is populated with the switches. The added space allows for an electronic device that only includes one PC board 204 and thus can be more compact in size as compared to electronic devices that include two PC boards. Preferably, the PC board 204 can also have shielding attached to the same side of the PC board 204 as the switches 206 such that electronic components on the PC board 204 which require shielding from electromagnetic radiation can be placed on the same side of the PC board 204 as the switches 206. On example of a PC board 204 including shielding is shown in FIG. 12.

Referring to FIG. 4, an isometric diagram is shown illustrating a front side of a PC board shown in FIG. 3. Show is a plurality of switches 302, a plurality of backlight light emitting diodes (LED's) 304, a microphone 306, a photosensor 308, and available space for electrical components 314.

The plurality of switches 302, the backlight LED's 304, the microphone 306, and the photosensor 308 are mounted on a front side of the PC board. As described above, the PC board can be a rigid PC board or a Flex. Preferably, the plurality of switches 302 are discrete switches such that room is left on the PC board for other electronic components. Shielding can also be coupled to the PC board such as is shown in FIG. 12.

Advantageously, there is a large amount of space left on the PC board for additional electronic components. This provides for a more compact design for the electronic device. The electronic device can be much thinner as compared to an electronic device that has more than one PC board.

Referring to FIG. 5, a side cross sectional view is shown illustrating a keypad and PC board in accordance an embodiment. Shown is a PC board 402, a front housing 404, a back housing 406, a plurality of switches 408, a plurality of available spaces for electrical components 410, a plurality of molded plungers 412, and a keypad film 414.

The PC board 402 is coupled to the front housing 404. The front housing is coupled to the back housing 406. The PC board 402 has a plurality of switches 408 attached to a front side of the PC board 402. The plurality of molded plungers 412 are placed in holes of the front housing 404 such that they contact the plurality of switches on the PC board 402. The keypad film 414 is coupled to the front housing 404 and serves to keep the plurality of molded plungers 412 in contact with the plurality of switches. Additionally shown are the plurality of available spaces for electronic components 410. The area between the switches can be used for placing additional electronic components on the front side of the PC board 402. Prior designs used Mylar popple switches that take up a much larger area on the PC board and thus the prior designs had a very limited space on the front of the PC board for any additional electronic components. Advantageously, the present design allows for a smaller design of the electronic device as the PC board can be reduced in size when electronic components can be placed on both sides of the PC board. Additionally, because more electronic components can be place on the PC board, all of the components required for the electronic device can be on a single PC board instead of more than one PC board. This also can reduce the size and thickness of the electronic device.

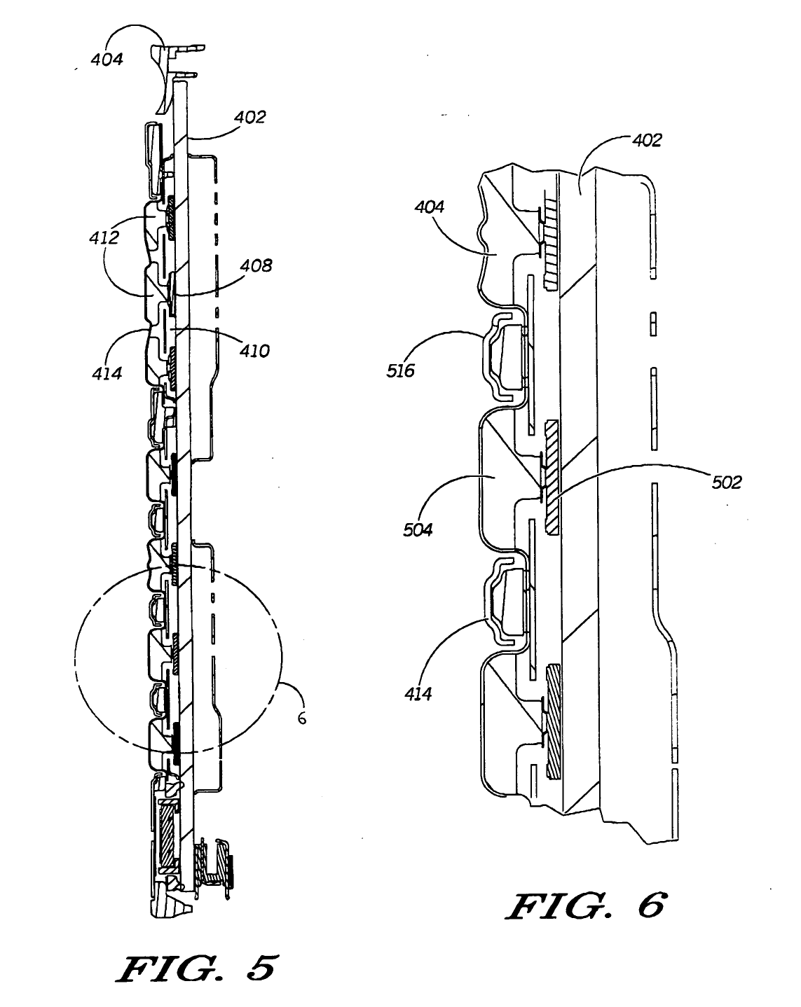

Referring to FIG. 6, a detailed side cross sectional view is shown illustrating part of the keypad shown in FIG. 5. Shown is the PC board 402, one of the plurality of switches 502, one of the plurality of molded plungers 504, the keypad film 414, a convex portion 516 of the keypad film 414, a portion of the front housing 404, and a portion of the back housing 406.

In a preferred embodiment, the keypad film 414 has a convex portion 516 around the molded plunger 504. Advantageously, this gives an optimal feel to the keypad keys such that a user of the electronic device has an easy to use interface for the electronic device. The convex portion 516 of the keypad film 414 around the molded plunger 504 also keeps the molded plunger 504 in place so that it properly engages the switch 504 on the PC board 402.

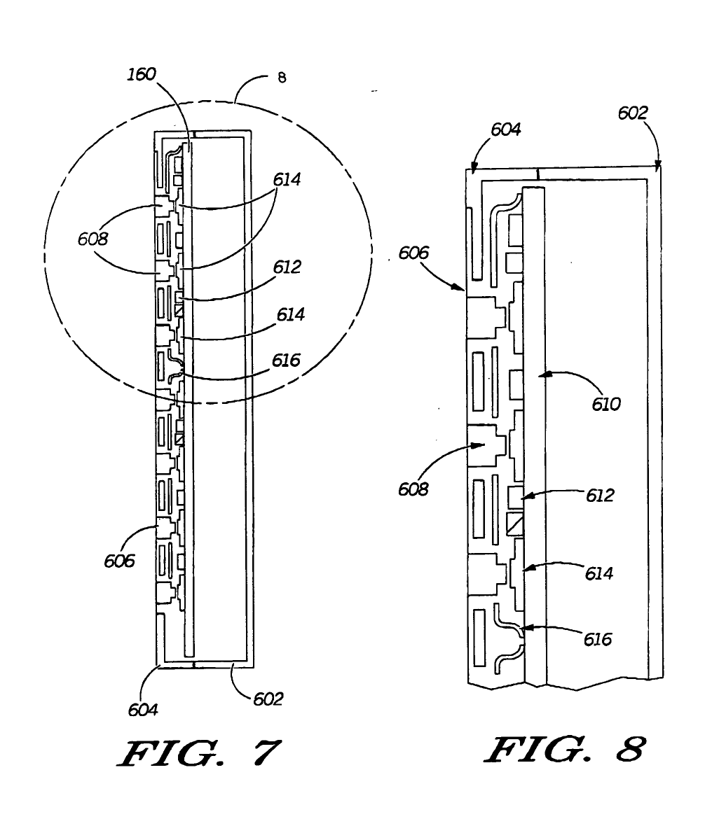

Referring to FIG. 7, a side cross sectional view is shown illustrating an electronic device housing and keypad in accordance with another embodiment. Shown is a back housing 602, a front housing 604, a keypad film 606, a plurality of plungers 608, a PC board 610, a plurality of electronic components 612, shielding 616, and a plurality of switches 614.

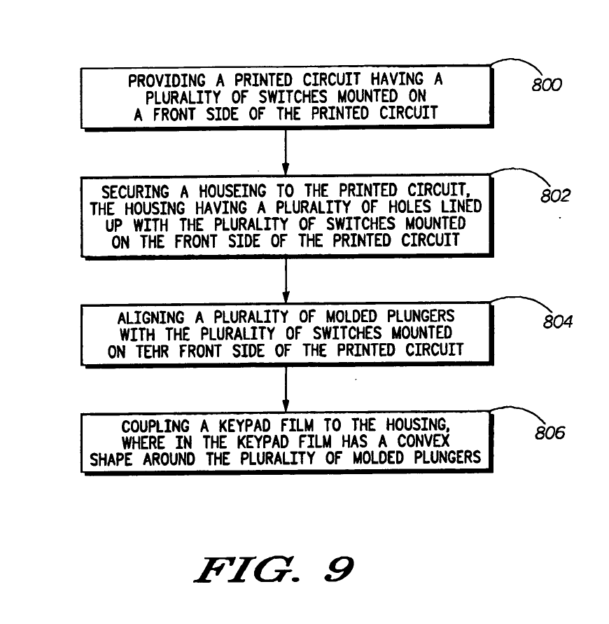

Referring to FIG. 8, a detailed side cross sectional view is shown illustrating part of the electronic device housing and keypad of FIG. 7. Shown is the back housing 602, the front housing 604, the keypad film 606, the plurality of plungers 608, the PC board 610, one of the plurality of electronic components 612, the shielding 616, and the plurality of switches 614.

The back housing 602 and the front housing 604 are coupled together to form a housing for the PC board 610. The PC board 610 has the plurality of switches 614 and the plurality of electrical components 612 attached to it. The electronic components 612 are placed in the space between the plurality of switches 616 on the front of the PC board 610. The plurality of plungers 608 are positioned to contact the plurality of switches 614. The keypad film 606 is coupled to the housing and holds the plurality of plungers 608 in place. In one embodiment, the keypad film 606 is attached to the front housing 604 using an adhesive.

As shown in FIG. 8, the PC board 610 has attached to it the plurality of electronic components 612 and the shielding 616. The shielding 616 can be placed on the same side of the PC board 610 as the switches 614 because there is additional space surrounding the discrete switches that would not be available is a traditional Mylar popple switch is used. The shielding 616 can be placed on the PC board 610 with holes in the shielding 616 such that the plungers can go through the holes and make contact with the switches on the PC board 610. Thus, electronic components that require shielding 616 can be placed on the same side of the PC board 610 as the switches 614, thus enabling a more compact design of an electronic device.

Referring now to FIG. 9, a flow diagram is shown illustrating an embodiment for assembling an electronic device.

First, a PC board or flexible printed circuit (i.e., printed circuit) is provided 800. The printed circuit includes a plurality of switches on one side of the printed circuit. In one embodiment, a plurality of electronic circuits or shielding can be placed on the printed circuit on the same side as the plurality of switches.

Next, a housing is secured to the printed circuit 802. The housing can be made of many types of material, e.g., plastic or metal, and can be formed from one or more parts. For example, as is shown in FIG. 6, the housing can be formed from the front housing section and the back housing section. The housing can be formed with a plurality of holes that line up with the plurality of switches on the printed circuit.

Following, a plurality of plungers are then aligned with the plurality of switches on the printed circuit 804.

A keypad film is then coupled to the housing 806. The keypad film keeps the plurality of plungers in place. In a preferred embodiment, the keypad film employs convex portions around the plungers to optimize the feel of the keypad keys.

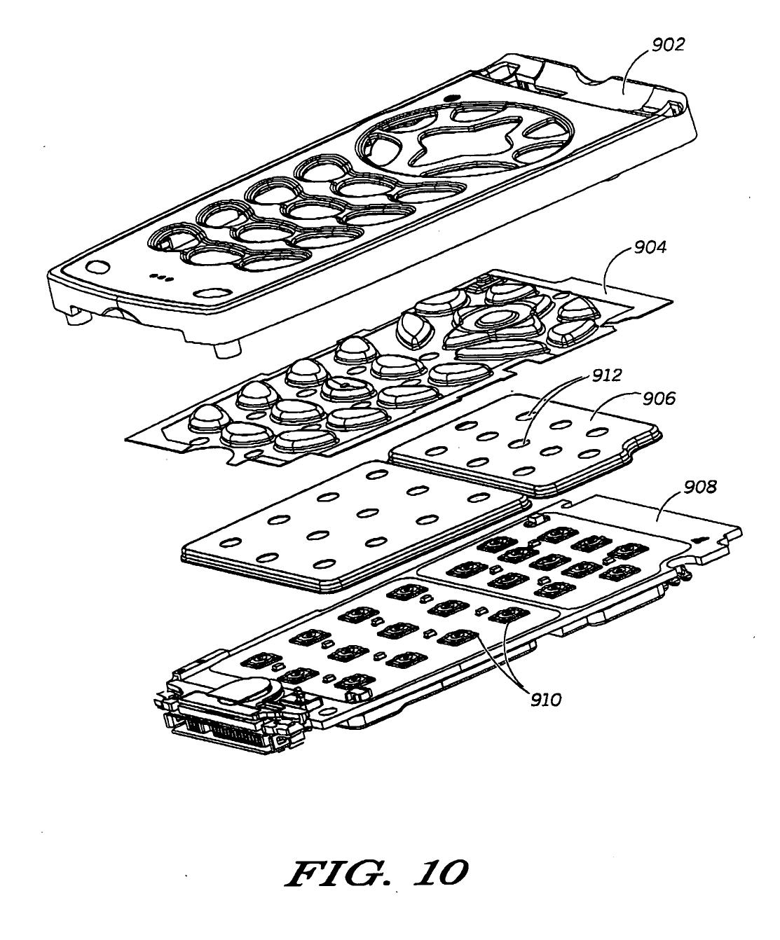

Referring now to FIG. 10, an exploded isometric diagram is shown illustrating an electronic device housing and a printed circuit board in accordance with an alternative embodiment. Shown is a front housing 902, a keypad film 904, shielding 906, a printed circuit board (PC board) 908, a plurality of switches 910, and a plurality of holes 912 in the shielding.

When assembled a plurality of keypad plungers are place in between the keypad film 904 and the shielding 906. The keypad plungers go through the holes 912 in the shielding 906 and contact the switches 910 on the PC board 908. The shielding 906 is attached to the PC board 908 and provides shielding for electronic components on the same side of the PC board 908 as the switches 910. A back housing, not shown is coupled to the back side of the PC board. The keypad can be adhered to inside or outside of the front housing 902. FIGS. 2, 3 and 7 show a typical embodiment with the keypad on the outside.

As shown, the keypad film 904 is on an inside of the front housing 902 of the electronic device. In this embodiment, the keypad film 904 is not susceptible to being removed from the outside of the front housing 902 as in the embodiment shown in FIG. 2. Additionally, in this embodiment, the keypad will have a much more conventional feeling to a user. The keypad film 904 will feel much more like the keypad buttons of prior designs.

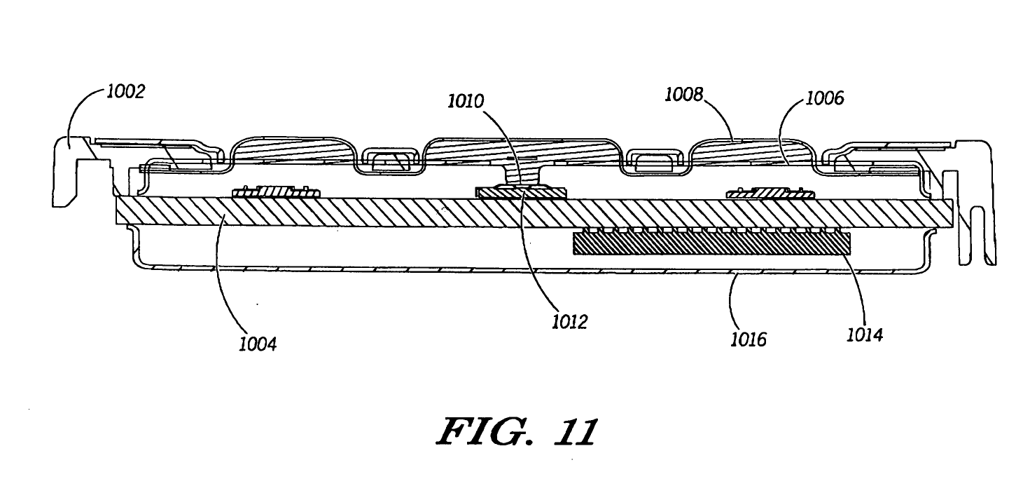

Referring now to FIG. 11, a top cross sectional view is shown illustrating an electronic device housing and printed circuit board in accordance with another embodiment. Shown is a front housing 1002, a PC board 1004, shielding on a front of the PC board 1006, a keypad film 1008, a plunger 1010, a switch 1012, an electronic component 1014, and shielding on the back of the PC board 1016.

The plunger 1010 fits through a hole in the shielding of the front of the PC board 1006 such that when the keypad film 1008 is depressed by a user the plunger 1010 will contact the switch 1012 on the front of the PC board 1006.

Referring to FIG. 12, an isometric diagram is shown illustrating a printed circuit board for an electronic device in accordance with an embodiment. Show is a plurality of switches 1102, a microphone 1104, a photosensor 1106, and a plurality of electronic components 1110.

The plurality of electronic components 1110 on the front of the PC board are able to be attached to the PC board in many different places. Compared to previous designs, the present embodiment has a much greater space on the front of the PC board available for the electronic components.

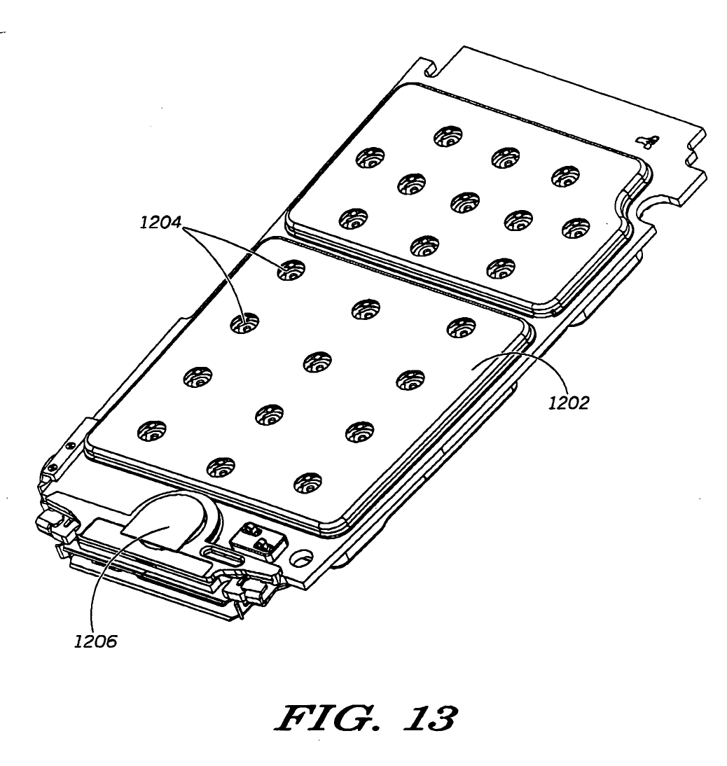

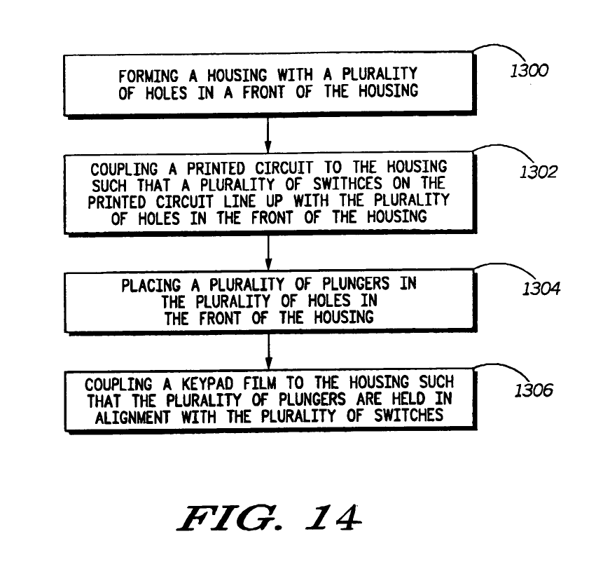

Referring to FIG. 13, an isometric diagram is shown illustrating shielding on a printed circuit board for an electronic device in accordance with an alternative embodiment. Shown is shielding 1202, a plurality of holes 1204 in the shielding 1202, and a microphone 1206.

The shielding 1202 can be included on the same side of the PC board as the plurality of switches, not shown, thus providing for space for the electronic components that can be placed on the front side of the board. The plurality of holes 1204 in the shielding 1202 line up with the switches, not shown, such that plungers fit through the holes and contact the switches. Prior designs were not able to include the shielding 1202 on the same side of the PC board as the Mylar popple switches because there is additional space surrounding the discrete switches that would not be available is a traditional Mylar popple switch is used.

Referring to FIG. 14, a flow diagram is show for assembling an electronic device according to an embodiment.

First, a housing is formed that includes a plurality of holes in a front of the housing 1300. The housing can be made from many different materials, including plastics or metals, and can be made from one or more parts. In a preferred embodiment the housing includes a front housing and a back housing.

Next, the printed circuit is coupled to the housing such that the plurality of switches on the printed circuit line up with the plurality of holes in the front of the housing 1302. A plurality of plungers are placed in the plurality of holes in the front of the housing 1304.

A keypad film is then coupled to the housing 1306. The keypad film will hold a plurality of plunger in contact with a plurality of switches on a printed circuit.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

We claim:

1. A mobile electronic device comprising:
a plurality of switches mounted on a printed circuit;
a housing coupled to the printed circuit;
a plurality of molded plungers for contacting the plurality of switches mounted on the printed circuit; and
a keypad film coupled to the housing, wherein the keypad film has a convex shape around at least one of the molded plungers.

2. The electronic device of claim 1 further comprising a plurality of electronic circuits mounted on the same side of the printed circuit as the plurality of switches.

3. The electronic device of claim 1 further comprising shielding mounted on the same side of the printed circuit as the plurality of switches.

4. The electronic device of claim 3 wherein the shielding has holes aligned with the plurality of switches such that the plurality of molded plungers still can contact the plurality of switches.

5. The electronic device of claim 1 wherein the electronic device only has one printed circuit.

6. The electronic device of claim 1 wherein the electronic device is a cellular telephone.

7. A keypad for an electronic device comprising:
a plurality of molded plungers for contacting a plurality of switches mounted on a printed circuit; and
a keypad film coupled to a housing of the electronic device, wherein the keypad film has a convex shape around at least one of the molded plungers keeping the at least one of the molded plungers in place.

8. The keypad of claim 7 further comprising an adhesive for coupling the keypad film to an outside of the housing.

9. The keypad of claim 7 wherein the keypad film is coupled to an inside of the housing.

10. The keypad of claim 7 wherein the keypad is used with a cellular telephone.

11. A method for assembling an electronic device comprising:
providing a printed circuit having a plurality of switches mounted on a front side of the printed circuit;
securing a housing to the printed circuit, the housing having a plurality of holes lined up with the plurality of switches mounted on the front side of the printed circuit;
aligning a plurality of molded plungers with the plurality of switches mounted on the front side of the printed circuit; and
coupling a keypad film to the housing, wherein the keypad film has a convex shape around the plurality of molded plungers.

12. The method of claim 11 further comprising attaching a plurality of electrical component to the front side of the printed circuit in an area between the plurality of switches.

13. The method of claim 12 further comprising coupling shielding to the front side of the printed circuit board.

14. The method of claim 13 wherein the shielding is provided to prevent the plurality of electric components from malfunctioning due to electromagnetic radiation.

15. A method for providing a keypad for an electronic device comprising the steps of:
forming a housing with a plurality of holes in a front of the housing;
coupling a printed circuit to the housing such that a plurality of switches on the printed circuit line up with the plurality of holes in the front of the housing;
placing a plurality of plungers in the plurality of holes in the front of the housing; and
coupling a keypad film to the housing such that the plurality of plungers are held in alignment with the plurality of switches.

16. The method of claim 15 further comprising the step of forming a convex portion of the keypad film around each of the plurality of plungers.

17. The method of claim 15 further comprising attaching a plurality of electrical component to the front side of the printed circuit in an area between the plurality of switches.

18. The method of claim 17 further comprising coupling shielding to the front side of the printed circuit board.

19. The method of claim 18 wherein the shielding is provided to prevent the plurality of electric components from malfunctioning due to electromagnetic radiation.
